(19) United States
(12) Patent Application Publication
(10) Pub. No.: US 2020/0159855 A1
(43) Pub. Date: May 21, 2020

(54) END-TO-END AUTOMATED SYSTEM FOR PERFORMING AN ACTION AS A RESULT OF PROCESSING UNSTRUCTURED DATA MISSION

(71) Applicant: BANK OF AMERICA CORPORATION, Charlotte, NC (US)

(72) Inventors: Shankar Iyer, East Windsor, NJ (US); Daljeet Singh, Plainsboro, NJ (US); Murali Kannan Santhana Krishnan, Charlotte, NC (US)

(73) Assignee: BANK OF AMERICA CORPORATION, Charlotte, NC (US)

(21) Appl. No.: 16/191,771

(22) Filed: Nov. 15, 2018

(51) Int. Cl. G06F 17/30; G10L 15/22

(52) U.S. Cl. CPC G06F 17/30616; G10L 2015/223; G10L 15/22; G06F 17/3043

(57) ABSTRACT

End-to-end automated performance of actions in response to receiving unstructured data from one of a plurality of action request channels and/or applications. A centralized service/engine is implemented that provides for consistent and reliable action results regardless of which channel/application initiated the request and/or which entity the request is associated with. Results consistency is further realized by structuring the unstructured data and extracting data elements therefrom that provide for determination of a predetermined action categories. The action categories define the automated processes, flows and/or tools required to complete the action.

### FIELD OF THE INVENTION

The present invention is generally directed to data processing and, more specifically, an end-to-end automated system for performing an action as a result of processing unstructured data.

### BACKGROUND

Many enterprises have a need to perform various actions in the course of business. These actions, otherwise referred to as events, tasks, jobs or the like, are typically repetitive in nature and may be semi manual/semi-automated or, in some instances, fully automated. In addition, the actions may be initiated internally, by associates, employees or the like or externally, by customers, third-party entities or the like.

As such, the data that is used to request the action and/or perform the action may be received from various different channels, such as electronic mail, voice mail, call center (interactive voice response (IVR)), facsimile, an online platform, a mobile application, a kiosk (e.g., automated teller machine) or the like. Such data, received from the various different channels, is in an unstructured format that is generally incompatible with the action to be performed. Each of the different data input channels may be associated with a channel-specific process (i.e., work flows, software application(s)/tool(s) and/or the like) for performing the action. Additionally, in large enterprises which may have many different globally-wide units, divisions and the like, such actions may occur via unit or division-specific processes. Such a diversity in processes leads to variance in results (i.e., the results of an action initiated at one channel may vary in comparison to the same action initiated at another channel and the results of an action performed by one unit or division may vary in comparison to the same action being performed by another unit or division).

Therefore, a need exists to develop a system for end-to-end automated performance of actions within an enterprise. As such, the desired systems, apparatus, methods should eliminate the need for much, if not all, manual processing, thus resulting in a more streamlined, efficient and reliable means for performing the actions at hand. The desired systems, apparatus, and methods should provide for a centralized means for performing the tasks, whereby most, if not all, action requests across an enterprise, received from different channels and/or different units/divisions or the like, are processed and performed in a consistent manner that results in reliable and repeatable results.

### BRIEF SUMMARY

The following presents a simplified summary of one or more embodiments of the invention in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, apparatus, methods and/or the like for end-to-end automated performance of actions, otherwise referred to as events, tasks, jobs or the like. The present invention is capable of ingesting unstructured data that requests an action from any action request channel and complete the action through a fully automated process. The unstructured data may include, but is not limited to, text data (e.g., electronic mail, word processing document, image file/document), audio data (e.g., recording voice file), video/multimedia data (e.g., recording video/multimedia file) and the like. The action request channels may include, but are not limited to, electronic mail, online platform/website, mobile application, facsimile, kiosk (e.g., automated teller machine), audio and/or video call center (e.g., IVR or the like) or the like.

The present invention is implemented as a service and, as such, an enterprise implementing the service is able to process most, if not all, action requests, regardless of which division, unit, LOB, or the like within the enterprise initiates the action request or which application/platform submits the action request. Moreover, the centralized/single engine approach of the present invention means that results are consistent and reliable regardless of which channel/application initiated the request and/or which unit/division within the enterprise the request is associated with.

In specific embodiments of the invention, an action performance service/engine ingests unstructured data from a plurality of different action request channels. As previously described, the unstructured data may take various different formats and the different action request channels may implement one or more diverse applications/tools for receiving the action requests. Once ingested, the unstructured data is converted to structured data and data elements from the structured data are extracted to determine one or more action categories from amongst a plurality of predetermined action categories, otherwise referred to herein as action classifications or classifications. By categorizing/classifying the action request in accordance with predetermined action categories the present invention insures that the result of the action request is consistent and reliable. Based on the action category/classification, further data is extracted that is required to perform the action and, if additional data is needed, systems of record (or if the systems of record are not able to provide requisite data, the action requester) is accessed to identify/determine the requisite data. Once the requisite data has been extracted and/or determined, the present invention orchestrates the automated processing of the action by invoking one or more predetermined Robotic Process Automation (RPA) tools, Business Process Management (BPM) tools, Information Technology (IT) tools or the like.

As such, the present invention, by implementing a centralized action performance engine that is configured to receive action requests from a plurality of different action request channels and/or application, provides consistent repeatable results across an enterprise or other invention-executing entity.

A system for end-to-end automated performance of an action defines first embodiments of the invention. The system includes a plurality of action request channels, each channel executes at least one application that is configured to receive user inputs that request one or more actions. The user inputs provide for unstructured data.

The system additionally includes a computing platform including a memory, and at least one processor in communication with the memory. In addition the system includes an end-to-end action performance service that is stored in the second memory, executable by the at least one second processor, and in communication with the plurality of action request channels. The end-to-end action performance service is configured to (i) ingest the unstructured data from the applications associated with the plurality of action request channels, (ii) convert the unstructured data to structured data, (iii) extract first data from the structured data to determine one or more action categories/classifications from amongst a plurality of predetermined action categories/classifications, and based on the one or more determined action categories/classifications (iv) extract second data from the structured data required to perform one or more actions, and (v) orchestrate an automated performance of the one or more actions based at least on the second data.

In specific embodiments of the system, the end-to-end action performance service is further configured to implement sentiment analytics to determine, from at least one of the unstructured data or the structured data, an expressive state exhibited by a user at a time when the action request channel received the user input. In such embodiments of the system, the end-to-end action performance service may further be configured to determine the one or more action categories/classifications based on the determined expressive state and/or orchestrate the end-to-end action performance service based on the determined expressive state.

In specific embodiments of the system, the unstructured data includes at least one audio data, video data, image data, and text data. In such embodiments of the system, the plurality of action request channels may include, but are not limited to, a call center, an interactive voice response system, an audio and/or video recording system, a mobile application, an online platform, an electronic telecommunications platform, electronic mail, facsimile, word processor file, and read-only image file. In such embodiments of the system the end-to-end action performance service is further configured to convert the unstructured data to structured data by implementing one or more of Natural Language Processing (NLP), Natural Language Understanding (NLU), Natural Language Generation (NLG), Optical Character Recognition (OCR), Intelligent Character Recognition (ICR), Machine Learning (ML) and Deep Learning (DL).

In other specific embodiments of the system, the end-to-end action performance service is further configured to (i) identify one or more data elements required to perform the one or more actions that are absent from the structured data, (ii) access one or more systems of record to retrieve the one or more data elements, and (iii) orchestrate the automated performance of the one or more actions based at least on the second data and the one or more data elements.

In other specific embodiments of the system, the end-to-end action performance service is further configured to (i) identify one or more data elements required to perform the one or more actions that are absent from the structured data, (ii) in response to accessing one or more systems of record and determining that at least one of the one or more data elements are absent from the one or more systems of record, initiating electronic communication to the user requesting the data elements, and (iii) in response to receiving a response communication from the user that includes the at least one of the one or more data elements, orchestrate the automated performance of the one or more actions based at least on the second data and the one or more data elements.

In further specific embodiments of the system, the end-to-end action performance service is further configured to orchestrate the automated performance of the one or more actions by integrating at least one of (i) one or more Robotic Process Automation (RPA) tools, (ii) one or more Business Process Management (BPM) tools, and (iii) one or more Information Technology (IT) tools.

An apparatus for end-to-end performance of an action defines second embodiments of the invention. The apparatus includes a computing platform including a memory and at least one processor in communication with the memory. The apparatus further includes an end-to-end action performance service that is stored in the memory, executable by the at least one processor. The end-to-end action performance service is configured to (i) ingest unstructured data from a plurality of disparate applications associated with a plurality of action request channels, (ii) convert the unstructured data to structured data, (iii) extract first data from the structured data to determine one or more action categories/classifications from amongst a plurality of predetermined action categories/classifications, and, based on the one or more determined action categories/classifications (iv) extract second data from the structured data required to perform one or more actions, and (v) orchestrate an automated performance of the one or more actions based at least on the second data.

In specific embodiments of the apparatus, the end-to-end action performance service is further configured to implement sentiment analytics to determine, from at least one of the unstructured data or the structured data, an expressive state exhibited by an inputter of the unstructured data at one of the plurality of action request channels. In such embodiments of the apparatus, end-to-end action performance service is further configured to determine the one or more action categories/classifications based on the determined expressive state and/or orchestrate the end-to-end action performance service based on the determined expressive state.

In still further specific embodiments of the apparatus, the end-to-end action performance service is further configured to convert the unstructured data to structured data by implementing one or more of Natural Language Processing (NLP), Natural Language Understanding (NLU), Natural Language Generation (NLG), Optical Character Recognition (OCR), Intelligent Character Recognition (ICR), Machine Learning (ML) and Deep Learning (DL).

In yet other specific embodiments of the apparatus, the end-to-end action performance service is further configured to (i) identify, from the structured data, one or more data elements required to perform the one or more actions that are absent from the structured data, (ii) access one or more systems of record to retrieve the one or more data elements, and (iii) orchestrate the automated performance of the one or more actions based at least on the second data and the one or more data elements. In other specific embodiments of the apparatus the end-to-end action performance service is further configured to (i) identify one or more data elements required to perform the one or more actions that are absent from the structured data, (ii) in response to accessing one or more systems of record and determining that at least one of the one or more data elements are absent from the one or more systems of record, initiating electronic communication to the user requesting the data elements, and (iii) in response to receiving a response communication from the user that includes the at least one of the one or more data elements, orchestrate the automated performance of the one or more actions based at least on the second data and the one or more data elements.

In further specific embodiments of the apparatus, the end-to-end action performance service is further configured to orchestrate the automated performance of the one or more actions by integrating at least one of (i) one or more Robotic Process Automation (RPA) tools, (ii) one or more Business Process Management (BPM) tools, and (iii) one or more Information Technology (IT) tools.

A computer-implemented method for end-to-end performance of an action defines third embodiments of the invention. The computer-implemented method is implemented by one or more processing devices and includes (i) ingesting unstructured data from one of a plurality of disparate applications associated with a plurality of action request channels, (ii) converting the unstructured data to structured data, (iii) extracting first data from the structured data to determine one or more action categories/classifications from amongst a plurality of predetermined action categories/classifications, and, based on the one or more determined action categories/classifications, (iv) extracting second data from the structured data required to perform one or more actions, and (v) orchestrating an automated performance of the one or more actions based at least on the second data.

In specific embodiments the computer-implemented method further includes implementing sentiment analytics to determine, from at least one of the unstructured data or the structured data, an expressive state exhibited by an inputter of the unstructured data at one of the plurality of action request channels. In such embodiments at least one of (i) determining the one or more action categories/classifications, and (ii) orchestrating the end-to-end action performance service is based on the determined expressive state.

Thus, according to embodiments of the invention, which will be discussed in greater detail below, the present invention provides for end-to-end automated performance of actions in response to receiving unstructured data from one of a plurality of action request channels and/or applications. The centralized/single engine approach of the present invention means that results are consistent and reliable regardless of which channel/application initiated the request and/or which entity the request is associated with. Consistency in results is realized by structuring the unstructured data and extracting data elements therefrom that provide for determination of a predetermined action categories/classifications. The action categories/classifications define the automated processes, flows and/or tools required to complete the action.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for end-to-end automated performance of an action as a result of processing unstructured action requesting data, in accordance with some embodiments of the present disclosure;

FIG. 2 is a block diagram of an apparatus configured for end-to-end automated performance of an action as a result of processing unstructured action requesting data, in accordance with some embodiments of the present disclosure;

FIG. 3 is a flow diagram of a method for end-to-end automated performance of an action as a result of processing unstructured action requesting data, in accordance with embodiments of the present invention; and

FIG. 4 is a flow diagram alternate methods for end-to-end automated performance of an action as a result of processing unstructured action requesting data, in accordance with some alternate embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, systems, apparatus, and methods are described in detail below for end-to-end automated performance of actions, otherwise referred to as events, tasks, jobs or the like as a result of receiving unstructured action request data from different action request channels and/or applications. The unstructured data may include, but is not limited to, text data (e.g., electronic mail, word processing document, image file/document), audio data (e.g., recording voice file), video/multimedia data (e.g., recording video/multimedia file) and the like. The action request channels may include, but are not limited to, electronic mail, online platform/website, mobile application, facsimile, kiosk (e.g., automated teller machine), audio and/or video call center (e.g., IVR or the like) or the like.

The present invention is implemented as a service and, as such, an enterprise implementing the service is able to process action requests, regardless of which division, unit, Line of Business (LOB), or the like within the enterprise initiates the action request and/or which channel/application the action request is received from. Moreover, the centralized/single engine approach of the present invention means that results are consistent and reliable regardless of which channel/application initiated the request and/or which unit/division within the enterprise the request is associated with.

The present invention relies on structuring the unstructured data and, subsequently extracting data elements from the structured data to determine one or more action categories, otherwise referred to as action classifications or classifications from amongst a plurality of predetermined action categories/classifications. By categorizing the action request in accordance with predetermined action categories/classifications the present invention insures that the process, work flow and/or tools used to perform the action are consistent and, thus, so too is the result.

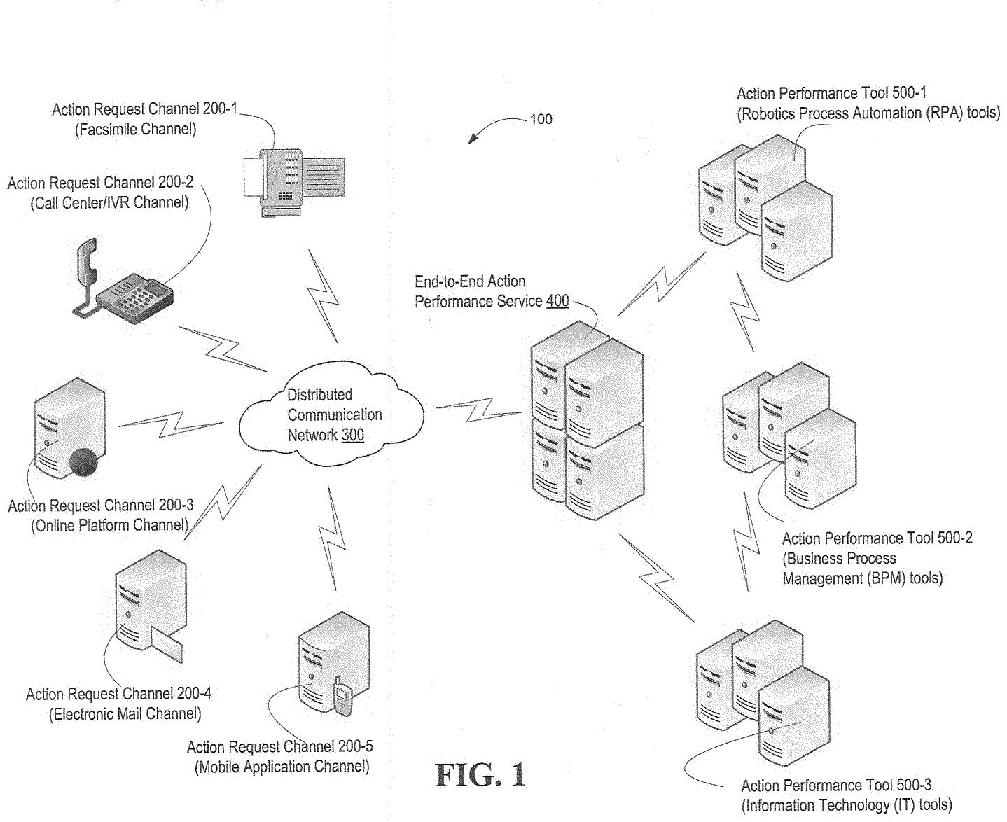

Turning now to the figures, FIG. 1 is a schematic diagram of an exemplary system 100 for end-to-end automated performance of an action in response to receiving unstructured action request data, in accordance with embodiments of the present invention. The system 100 comprises a plurality of action request channels 200 that execute at least one application (not shown in FIG. 1) that is configured to receive user inputs, in unstructured data form, that request one or more actions, otherwise referred to as events, tasks, jobs or the like. In an enterprise environment the action request channels 200 may comprise most, if not all, of the conceivable data entry points within the enterprise. Within an enterprise the users who request an action may be internal entities (e.g., associates, employees, or the like), external entities (e.g., customers) and/or third-party entities (e.g., contractors, vendors or the like) and, thus, the action request channels 200 may be internal or external action request channels. In the illustrated embodiment of FIG. 1 the action request channels 200-1-200-5 are merely examples of specific types of action request channels and, therefore should not be construed as limiting. The illustrated examples include a facsimile channel 200-1, a call center/IVR channel 200-2, on online platform channel 200-3, an electronic mail channel 200-4, and a mobile application channel 200-5. Other action request channels 200 not shown in FIG. 1 may include a kiosk/ATM channel, a multimedia/video conference channel and the like.

The unstructured data that forms the user inputs may include, but is not limited to, email data, audio/voice data, multimedia/video data, facsimile data, word document file (e.g., .doc, .pdf or the like), image document file (e.g., .jpeg, .bmp or the like)). It should be noted that the user in submitting the inputs may be unaware that they are submitting data that includes one or more action requests. For example, the user inputs may be general comments concerning the enterprise, which may or may prompt the system to request an action.

The system 100 additionally includes an end-to-end action performance service 400 that is in communication with the plurality of action request channels 200 via distributed communication network 300. The end-to-end action performance service 400 may be in direct (as shown in FIG. 1) or indirect wired and/or wireless communication with the plurality of action request channels 200 such that the end-to-end action performance service 400 is configured to ingest/receive the unstructured data from the applications associated with the plurality of action request channels 200. Indirect communication provides for an intermediary entity within the network to receive the unstructured data from the applicable action request channel 200 prior to communicating the unstructured data to the end-to-end action performance service 400. As previously, discussed by structuring the end-to-end action performance service 400 as a service an enterprise or other entity implementing the service is able to offer the service to any division, unit, LOB or the like within the enterprise.

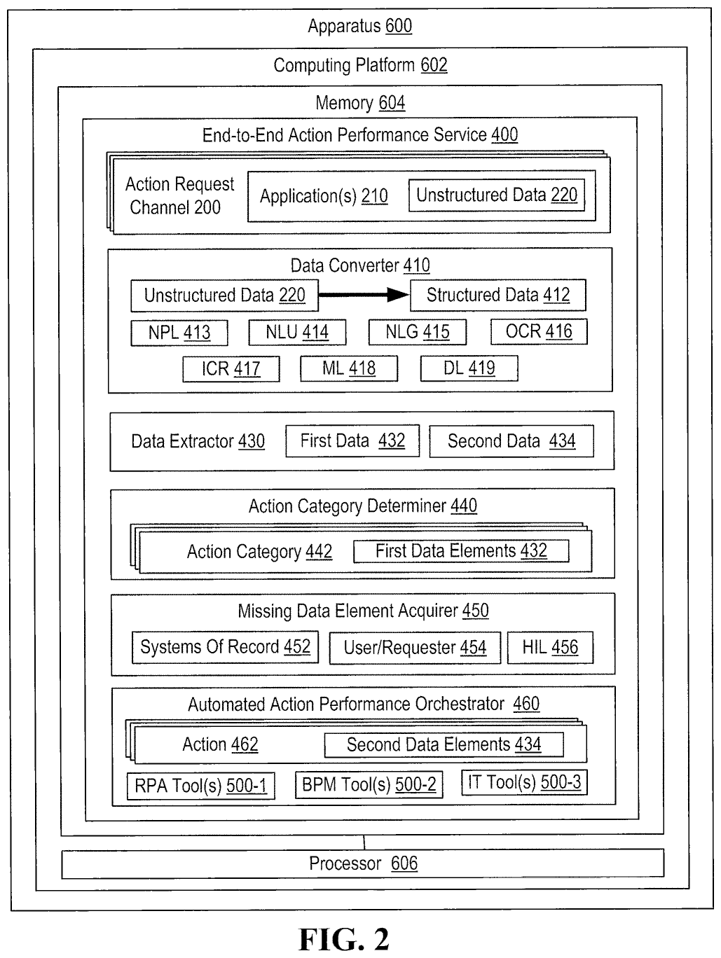

As will be discussed in more detail with regards to FIG. 2, the end-to-end action performance service 400 is configured to ingest/receive the unstructured data from the applications associated with the plurality of action request channels and convert the unstructured data to structured data. Once the data has been properly structured, data elements from the structured data are extracted to determine one or more action categories/classifications from amongst a plurality of predetermined action categories/classifications. For example, within an enterprise such as a financial institution, the action categories/classifications may include, but are not limited to, an account opening category/classification, a debit/credit card request category/classification, a check request category/classification, a fraud investigation category/classification, an anti-money laundering category/classification and the like. By categorizing the action the present invention is able to define the work, flow, processes and/or tools that are implemented to perform the action and, thus, insure consistent and reliability results. Based on the identified action category(s)/classification(s), the end-to-end action performance service 400 is further configured to extract further data from the structured data that is required to perform the one or more actions and orchestrate the automated performance of the action(s) based on the second data.

In this regard, orchestrating the automated performance of the action includes communicating the further data to one or more action performance tools 500, which, in turn, perform one or more steps in the overall automated action process. Such action performance tools 500 may include, but are not limited to, Robotics Process Automation (RPA) tools 500-1, Business Process Management (BPM) tools 500-2, traditional Information Technology (IT) tools 500-3 and the like. The action may be performed by one or more tools. In those embodiments in which multiple tools are implemented to perform the action, the steps performed by the tools may be performed in parallel or in series depending on the type of action being performed. As such, the service 400 may communicate the further data to a single tool 500, which subsequently forwards the data to downstream tools or the service 400 may communicate at least a portion of the requisite further data to multiple tools 500 on an as-needed basis. Orchestration of the automated performance by the service 400 may include, but is not limited to, insuring that the tools 500 adhere to a requisite work flow/process, insuring that steps within the workflow/process are performed properly and within requisite time constraints and insuring that the overall action is performed satisfactory and within requisite time constraints.

Referring to FIG. 2 a block diagram is presented of an apparatus 600 that includes the end-to-end action performance service 400, in accordance with embodiments of the present invention. The apparatus 600 may include one or multiple different computing devices, such as servers or the like. The apparatus includes a computing platform 602 that includes a memory 604 and at least one processor 606 in communication with the memory 604.

The memory 604 may comprise volatile and non-volatile memory, such as read-only and/or random-access memory (RAM and ROM), EPROM, EEPROM, flash cards, or any memory common to computing platforms). Moreover, memory 604 may comprise cloud storage, such as provided by a cloud storage service and/or a cloud connection service. Processor 606 may be an application-specific integrated circuit (“ASIC”), or other chipset, logic circuit, or other data processing device. Processor 606 may execute one or more application programming interface (APIs) (not shown in FIG. 2) that interfaces with any resident programs, such as end-to-end action performance service 400. Processor 606 may include various processing subsystems (not shown in FIG. 2) embodied in hardware, firmware, software, and combinations thereof, that enable the functionality of computing platform 602 and the operability of the computing platform 602 on the distributed communication network 200 through which unstructured data provided by the action request channels 200 is ingested/received.

Memory 606 of computing platform 602 stores end-to-end-action performance service 400 that is configured to ingest unstructured data 220 from the applications 210 associated with the plurality of action request channels 200 described in FIG. 1. As previously discussed, the unstructured data may take many different forms, including, but not limited to, email data, audio/voice data, multimedia/video data, facsimile data, word document file (e.g., .doc, .pdf or the like), image document file (e.g., .jpeg, .bmp or the like)) or the like. It should also be noted that in specific embodiments of the invention, the end-to-end-action performance service 400 may be configured to ingest structured data (i.e., text data, digital/computer-readable data or the like that is formatted for action category determination or the like), obviating the need to subsequently convert such structured data.

The end-to-end-action performance service 400 is configured to execute data converter 410 to convert the unstructured data 220 to structured data 412 (e.g., text data or the like suitable for action category determination and extraction of data required to perform the action). The data converter 410 may use one or more known or future known data conversion applications, such as, but not limited to, Natural Language Processing (NLP) 413, Natural Language Understanding (NLU) 414, Natural Language Generation (NLG) 415, Optical Character Recognition (OCR) 416, Intelligent Character Recognition (ICR) 417, Machine Learning (ML) 418 and Deep Learning (DL) 419 or the like.

In response to converting the data to a structured format, the end-to-end-action performance service 400 is configured to execute data extractor 430 to extract first data elements 432 from the structured data 412 and execute action category/classification determiner 440 to determine/identify one or more predetermined action categories/classifications 442 based on the first data elements 432. The data extractor 430 and/or the action category/classification determiner 440 may rely on ML 418, DL 420 or any other analytical tool to determine which data to extract from the structured data and/or which action categories/classifications 442 are applicable. In specific embodiments of the invention, a single user input (i.e., unstructured data item) may result in determination of more than one action category/classification 442, such that, more than one action is performed in response to the single user input. As previously discussed within an enterprise such as a financial institution, the action categories/classifications may include, but are not limited to, an account opening category/classification, a debit/credit card request category/classification, a check request category/classification, a fraud investigation category/classification, an anti-money laundering category/classification and the like. In additional embodiments of the invention, systems of record or the like may be accessed to determine a sub-category/classification for the structured data based on the extracted first data elements 432. For example, if the first data elements 432 identifies the user, systems of records may be accessed to determine a classification associated with the user (e.g., priority customer or the like) and the classification associated with the user may define a level or sub-category/classification within the category/classification. The level or sub-category/classification within a category/classification may define level of service for performing the action, such as, time for performance, quality of performance or the like.

In response to determining the one or more action categories/classifications 442, data extractor 430 is executed to extract second data elements 434 that are required to perform the action 462 associated with the action category/classification 442. In the event that the extraction of the second data elements 434 from the structured data 412 results in missing data elements required to perform the action, missing data element acquirer 450 is executed to acquire further data elements that are required to perform the action. In specific embodiments of the invention, the missing data element acquirer 450 is configured to access one or more systems of record 452 (e.g., associate profiles, customer profiles or the like) to identify and retrieve one or more missing data elements. In other specific embodiments of the invention, in response to determining that the second data elements are not inclusive of all the data elements required to perform the action and/or the systems of record 452 do not include the missing/absent data elements, the missing data element acquirer 450 is configured to automatically initiate an electronic communication (e.g., text/SMS message, email or the like) to the user/requester 454 requesting the missing/absent data elements. In response to receiving a response from the user, the data converter 410 may be executed to convert the unstructured data in the response (i.e., text/SMS message, email or the like) to structured data for the purpose of making data extraction possible. In addition, in the event that (i) extraction of the second data elements 434 from the structured data 412 results in missing data and/or (ii) the systems of record 452 do not include the missing/absent data elements and/or (iii) no electronic communication is sent to the user/requester 454 and/or (iv) no/inadequate response is received, the end-to-end-action performance service 400 may invoke Human In the Loop (HIL) processing 456, in which a system user provides input/feedback to train the end-to-end-action performance service 400 and improve the accuracy progressively.

The end-to-end action performance service 400 is further configured to execute automated action performance orchestrator 460 that is configured to orchestrate the performance of the action(s) 462 associated with the predetermined action category(s) 442 based at least one the second data elements 434 and, in some embodiment the further requisite data elements, retrieved from the systems of record 452 or the user/requester 454. As previously discussed, orchestrating the automated performance of the action includes communicating the second data elements 434 and any further data elements to one or more action performance tools 500, which, in turn, perform one or more steps in the overall automated action process. Such action performance tools 500 may include, but are not limited to, Robotics Process Automation (RPA) tools 500-1, Business Process Management (BPM) tools 500-2, traditional Information Technology (IT) tools 500-3 and the like. Further the automated action performance orchestrator 460 may communicate instructions to the tools 500 including, but not limited to, workflow, time constraints, processing priority or the like. The tools are configured to perform the action to completion with minimal and, in some embodiments, no manual intervention.

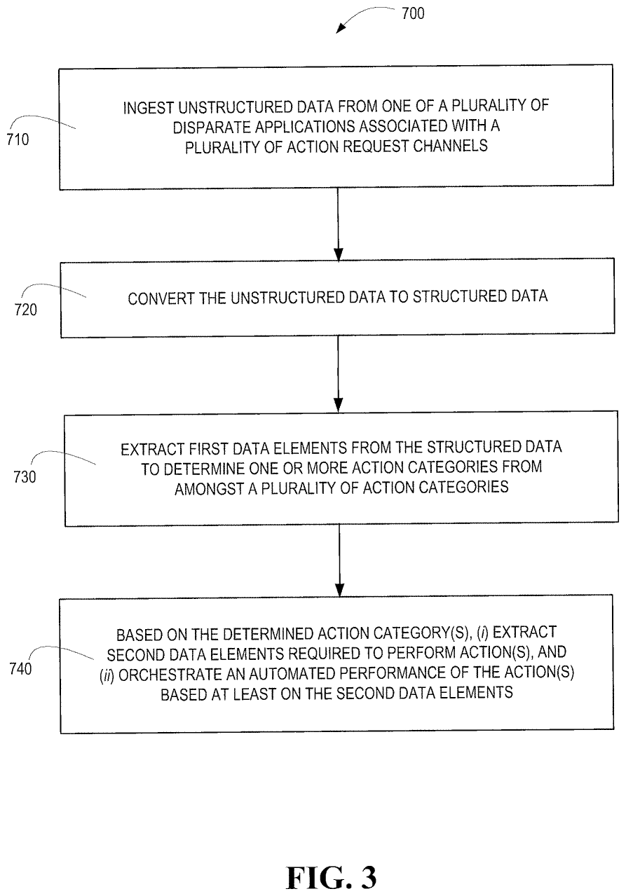

Referring to FIG. 3 a flow diagram is present of a method 700 for end-to-end automated performance of actions as a result of processing unstructured data, in accordance with embodiments of the present invention. At Event 710, unstructured data is ingested/received from one of a plurality of disparate applications associated with a plurality of action request channels. As previously discussed the unstructured data may take the form of email, a word processing file, an image document file, audio data, multimedia/video data, or the like. The applications and/or action request channels may include, but are not limited to, email (including word processing and/or image document file attachments), online platform, mobile application, kiosk/ATM, call center/IVR, multimedia/video conference or the like.

At Event 720 the unstructured data is converted to structured data. Such structuring of the data may include, but is not limited to, implementing Natural Language Processing (NLP) applications, Natural Language Understanding (NLU) applications, Natural Language Generation (NLG) applications, Optical Character Recognition (OCR) applications, Intelligent Character Recognition (ICR) applications, Machine Learning (ML) applications, Deep Learning (DL) applications and/or other analytical or cognitive applications, tools or the like configured to assist in structuring the data into a compatible format (e.g., suitable for determining action categories and data extraction).

At Event 730, first data elements are extracted from the structured data to determine one or more action categories from amongst a plurality of predetermined action categories. In such embodiments of the invention, Machine Learning (ML) applications, Deep Learning (DL) applications and/or other analytical and cognitive applications and tools may be used to determine the action categories. As previously discussed by classifying the data into action categories the present invention is configured to define workflows, processes and tools to perform the action in a consistent and reliable manner.

At Event 740, in response to determining one or more action categories, second data elements are extracted from the structured data. The second data elements, which may comprise all or a portion of the first data elements, are data elements that are required by the downstream action performing tools in order to perform the action. In specific alternate embodiments of the method, additional required data elements are retrieved from systems of record or acquired via inquiry to the user/action requester. In addition, automated performance of the action is orchestrated based at least on the second data elements. Orchestration may include, but is not limited to, invoking one or more tools to perform the action, monitoring the performance to insure compliance to regulations, workflows, timing requirements and the like and performing quality assurance checks to insure that the result of the action is compliant to standards, meets processing requirements and the like.

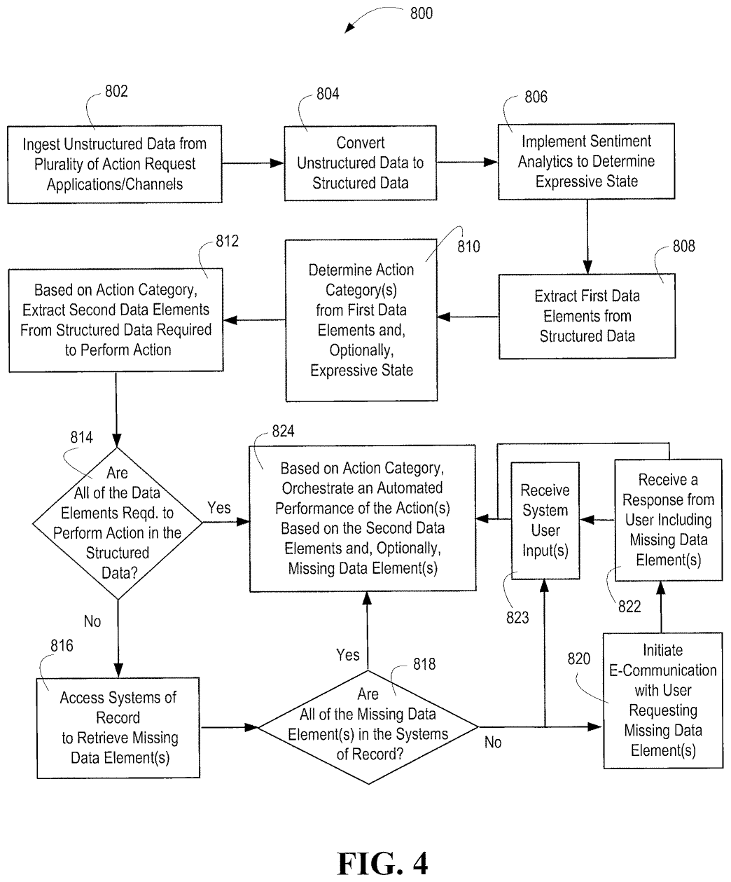

Referring to FIG. 4 a flow diagram is present of an alternate method 800 for end-to-end automated performance of actions as a result of processing unstructured data, in accordance with specific alternate embodiments of the present invention. At Event 802, unstructured data is ingested/received from one of a plurality of disparate applications associated with a plurality of action request channels. As previously discussed the unstructured data may take the form of email, a word processing file, an image document file, audio data, multimedia/video data, or the like. The applications and/or action request channels may include, but are not limited to, email (including word processing and/or image document file attachments), online platform, mobile application, kiosk/ATM, call center/IVR, multimedia/video conference or the like.

At Event 804 the unstructured data is converted to structured data. Such structuring of the data may include, but is not limited to, implementing Natural Language Processing (NLP) applications, Natural Language Understanding (NLU) applications, Natural Language Generation (NLG) applications, Optical Character Recognition (OCR) applications, Intelligent Character Recognition (ICR) applications, Machine Learning (ML) applications and Deep Learning (DL) applications and/or other analytical or cognitive applications, tools or the like configured to assist in structuring the data into a compatible format (e.g., suitable for determining action categories and data extraction).

At optional Event 806, semantics analytics are implemented to determine the expressive state of the of the user/action requester. In specific embodiments of the invention, determination of the expressive state of the user/action requester may be optional (e.g., email), while in other embodiments such a determination may be required (e.g., voice mail). The semantics analytics may be applied to the unstructured data and/or the structured data to determine the user's expressive state at the time of the user input/action request. For example, the expressive state may indicate that the user was upset, excited, anxious or the like. In optional embodiments of the invention, the expressive state of the user/action requester may be used to determine that action category or a level sub-category within the action category and/or the expressive state of the user/action requester may be used to determine parameters (e.g., time limitations/thresholds for performing the action) for performing the action, which may be communicated to the one or more action performance tools.

At Event 808, first data elements are extracted from the structured data and, at Event 810, one or more action categories are determined from amongst a plurality of predetermined action categories based at least on the extracted first data elements and, optionally, the expressive state of the user/data/requester. In such embodiments of the invention, Machine Learning (ML) applications, Deep Learning (DL) applications and/or other analytical and cognitive applications and tools may be used to determine the action categories.

At Event 812, in response to determining one or more action categories, second data elements are extracted from the structured data. The second data elements, which may comprise all or a portion of the first data elements, are data elements that are required by the downstream action performing tools in order to perform the action.

At Decision 814, a determination is made to as to whether all of the data elements required to perform the action have been extracted from the structured data. At Event 816, in response to determining that required data elements are absent from the structured data, systems of record (e.g., associate/customer profile data, account data and the like) are accessed to retrieve the missing data elements. At Decision 818, a determination is made as to whether all of the absent data elements required to perform the action have been retrieved from the systems of record. At Event 820, in response to determining that one or more missing data elements were unable to be retrieved from the systems of record, an electronic communication (e.g., text/SMS message, email or the like is generated and communicated to the user/action requester requesting the absent data elements and, at Event 822, a response is received and confirmation is made that the response includes the requisite absent data elements. Confirmation and access to the missing data elements may include converting the unstructured response to structured data.

At Event 823, in response to (i) determining, at Decision 818, that all of the absent data elements have not been retrieved from the systems of record, and/or (ii) determining that e-communication was not sent to the user/requester, a response was not received from the user/action requester or the user/action requester response does not include all of the absent data elements, a system user may provide inputs to the system. In a system training mode or the like, the user inputs may include, but are not limited to, additional information or a source (e.g., system of record or the like) for the missing data elements that the system can retrieve the missing data elements from. In a “live” action processing mode, the user inputs may include, but are not limited to, the missing data elements required to perform the action, as well as, providing inputs that identify a source (i.e., further system training).

At Event 824, in response to (i) determining at Decision 814 that all of the data elements required to perform the action are included in the structured data, or (ii) determining, at Decision 818, that all of the absent data elements have been retrieved from the systems of record, or (iii) at Event 820 confirming that the user/action requester response includes all of the absent data elements, or (iv) receiving system user inputs, automated performance of the action is orchestrated based at least on the second data elements. Orchestration may include, but is not limited to, invoking one or more tools to perform the action, monitoring the performance to insure compliance to regulations, workflows, timing requirements and the like and performing quality assurance checks to insure that the result of the action is compliant to standards, meets processing requirements and the like.

Thus, present embodiments of the invention providing systems, apparatus methods and/or the like provide for end-to-end automated performance of actions, otherwise referred to as events, tasks, jobs or the like in response to receiving unstructured action request data from one of a plurality of action request channels and/or applications. The centralized engine/service approach of the present invention means that results are consistent and reliable regardless of which channel/application initiated the request and/or which entity the request is associated with. Result consistency is further realized by structuring the unstructured data and extracting data elements therefrom that provide for determination of a predetermined action categories. The action categories define the automated processes, flows and/or tools required to complete the action.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for end-to-end automated performance of an action, the system comprising:
a plurality of action request channels, each channel executing at least one application that is configured to receive user inputs that requests one or more actions, wherein the user inputs provide for unstructured data;
a computing platform including a memory, and at least one processor in communication with the memory; and
an end-to-end action performance service stored in the memory, executable by the at least one processor, in communication with the plurality of action request channels and configured to:
ingest the unstructured data from the applications associated with the plurality of action request channels,
convert the unstructured data to structured data,
extract first data from the structured data to determine one or more action categories from amongst a plurality of predetermined action categories, and
based on the one or more determined action categories:
extract second data from the structured data required to perform one or more actions, and
orchestrate an automated performance of the one or more actions based at least on the second data.

2. The system of claim 1, wherein the end-to-end action performance service is further configured to implement sentiment analytics to determine, from at least one of the unstructured data or the structured data, an expressive state exhibited by user at a time when the action request channel received the user input.

3. The system of claim 1, wherein the end-to-end action performance service is further configured to determine the one or more action categories based on the determined expressive state.

4. The system of claim 1, wherein the end-to-end action performance service is further configured to orchestrate the automated performance of the one or more actions based on the determined expressive state.

5. The system of claim 1, wherein the unstructured data includes at least one audio data, video data, image data, and text data.

6. The system of claim 5, wherein the end-to-end action performance service is further configured to convert the unstructured data to structured data by implementing one or more of Natural Language Processing (NLP) applications, Natural Language Understanding (NLU) applications, Natural Language Generation (NLG) applications, Optical Character Recognition (OCR) applications, Intelligent Character Recognition (ICR) applications, Machine Learning (ML) applications and Deep Learning (DL) applications.

7. The system of claim 1, wherein the end-to-end action performance service is further configured to:
identify one or more data elements required to perform the one or more actions that are absent from the structured data,
access one or more systems of record to retrieve the one or more data elements, and
orchestrate the automated performance of the one or more actions based at least on the second data and the one or more data elements.

8. The system of claim 1, wherein the end-to-end action performance service is further configured to:
identify one or more data elements required to perform the one or more actions that are absent from the structured data,
in response to accessing one or more systems of record and determining that at least one of the one or more data elements are absent from the one or more systems of record, initiating electronic communication to the user requesting the data elements, and
in response to receiving a response communication from the user that includes the at least one of the one or more data elements, orchestrate the automated performance of the one or more actions based at least on the second data and the one or more data elements.

9. The system of claim 1, wherein the end-to-end action performance service is further configured to orchestrate the automated performance of the one or more actions by integrating at least one of (i) one or more Robotic Process Automation (RPA) tools, (ii) one or more Business Process Management (BPM) tools, and (iii) one or more Information Technology (IT) tools.

10. The system of claim 1, wherein the plurality of action request channels include a call center, an interactive voice response system, a mobile application, an online platform, an electronic telecommunications platform, electronic mail, facsimile, word processor file, and read-only image file.

11. An apparatus for end-to-end performance of an action, the apparatus comprising:
a computing platform including a memory and at least one processor in communication with the memory; and
an end-to-end action performance service stored in the memory, executable by the at least one processor and configured to:
ingest unstructured data from one of a plurality of disparate applications associated with a plurality of action request channels,
convert the unstructured data to structured data,
extract first data from the structured data to determine one or more action categories from amongst a plurality of predetermined action categories, and
based on the one or more determined action categories:
extract second data from the structured data required to perform one or more actions, and
orchestrate an automated performance of the one or more actions based at least on the second data.

12. The apparatus of claim 11, wherein the end-to-end action performance service is further configured to implement sentiment analytics to determine, from at least one of the unstructured data or the structured data, an expressive state exhibited by an inputter of the unstructured data at one of the plurality of action request channels.

13. The apparatus of claim 12, wherein the end-to-end action performance service is further configured to determine the one or more action categories based on the determined expressive state.

14. The apparatus of claim 11, wherein the end-to-end action performance service is further configured to orchestrate the end-to-end action performance service based on the determined expressive state.

15. The apparatus of claim 11, wherein the end-to-end action performance service is further configured to convert the unstructured data to structured data by implementing one or more of Natural Language Processing (NLP) applications, Natural Language Understanding (NLU) applications, Natural Language Generation (NLG) applications, Optical Character Recognition (OCR) applications, Intelligent Character Recognition (ICR) applications, Machine Learning (ML) applications and Deep Learning (DL) applications.

16. The apparatus of claim 11, wherein the end-to-end action performance service is further configured to:
identify, from the structured data, one or more data elements required to perform the one or more actions that are absent from the structured data,
access one or more systems of record to retrieve the one or more data elements, and
orchestrate the automated performance of the one or more actions based at least on the second data and the one or more data elements.

17. The apparatus of claim 11, wherein the end-to-end action performance service is further configured to:
identify one or more data elements required to perform the one or more actions that are absent from the structured data,
in response to accessing one or more systems of record and determining that at least one of the one or more data elements are absent from the one or more systems of record, initiating electronic communication to the user requesting the data elements, and
in response to receiving a response communication from the user that includes the at least one of the one or more data elements, orchestrate the automated performance of the one or more actions based at least on the second data and the one or more data elements.

18. The system of claim 11, wherein the end-to-end action performance service is further configured to orchestrate the automated performance of the one or more actions by integrating at least one of (i) one or more Robotic Process Automation (RPA) tools, (ii) one or more Business Process Management (BPM) tools, and (iii) one or more Information Technology (IT) tools.

19. A computer-implemented method for end-to-end performance of an action, the computer-implemented method is implemented by one or more processing devices and comprises:
ingesting unstructured data from one of a plurality of disparate applications associated with a plurality of action request channels,
converting the unstructured data to structured data,
extracting first data from the structured data to determine one or more action categories from amongst a plurality of predetermined action categories, and
based on the one or more determined action categories, extracting second data from the structured data required to perform one or more actions, and orchestrating an automated performance of the one or more actions based at least on the second data.

20. The computer-implemented method of claim 19, further comprising:
implementing sentiment analytics to determine, from at least one of the unstructured data or the structured data, an expressive state exhibited by an inputter of the unstructured data at one of the plurality of action request channels,
wherein at least one of (i) determining the one or more action categories, and (ii) orchestrating the end-to-end action performance service is based on the determined expressive state.
